(19) United States
(12) Patent Application Publication
(10) Pub. No.: US 2014/0180967 A1
(43) Pub. Date: Jun. 26, 2014

(54) DESIGN SUPPORT SYSTEM FOR FINANCIAL PRODUCTS OF DIVISIONAL PAYMENT TYPE

(71) Applicants: Han Yong Cho, Seoul (KR); Sung Yong Hong, Incheon (KR); Doo Won Kim, Namyangju-si (KR); Jin Heung Bae, Seoul (KR)

(72) Inventors: Han Yong Cho, Seoul (KR); Sung Yong Hong, Incheon (KR); Doo Won Kim, Namyangju-si (KR); Jin Heung Bae, Seoul (KR)

(21) Appl. No.: 14/236,151

(22) PCT Filed: Oct. 28, 2011
(86) PCT No.: PCT/KR2011/008140

§ 371 Date: Jan. 30, 2014

(30) Foreign Application Priority Data
Aug. 1, 2011 (KR) 10-2011-0076674

(51) Int. Cl. G06Q 40/06

(52) U.S. Cl. CPC G06Q 40/06
USPC 705/36 R

(57) ABSTRACT

The present invention relates to a design support system for financial products of a divisional payment type (FPD). A plurality of computing modules according to the present invention are systematically disposed within a communication pipeline of an FPD sales staff's communication terminal which is connected to an online network so that the FPD sales staff can provide FPD design particulars corresponding to desires of customers whom the FPD sales staff is handling without any particular difficulties in real time using the modules. Accordingly, it is possible to guide the FPD sales staff and an FPD management company, and furthermore, each customer can easily avoid problems related to reduction in business efficiency or sales efficiency of the FPD, and the inability to rapidly invest in and possess desired FPD, and the like.

### TECHNICAL FIELD

The present disclosure relates to a system for designing a financial product of a divisional payment type (FPD) according to a demand of a customer, and more particularly, to a FPD design supporting system for allowing a FPD sales manager to give FPD design details corresponding to a need of a customer, who is meeting the manager, in real time without any difficulty in order to prevent serious deterioration of FPD business efficiency or FPD sales efficiency in view of a FPD sales manager, a FPD management company and each customer, and also to solve a problem that a desired FPD cannot be invested or possessed rapidly.

### BACKGROUND ART

Recently, FPD in which a part of an investment profit of a customer is divisionally paid before its maturity date has been developed by the inventor of this application and is being widely propagated. As an example of such FPD, Korean Patent Application No. 10-2010-62964 filed by the applicant of this application and entitled “a system for operating an investment money” discloses <FPD for supporting a customer (a person customer, a company customer or the like) who invests or operates an investment money to be assured of the principal of the investment money and be periodically endowed of a bonus money over a certain level at every time>.

In the above system, as shown in FIG. 1, a FPD sales manager D who takes a charge of selling a FPD 1 at a meeting with a customer C introduces design details 1a (for example, a product type, an investment period, an available on-term benefit, an available maturity benefit or the like) of each FPD 1 and sells a corresponding FPD 1 to the customer C according to the selection of the customer. In this case, each FPD 1 introduced to the customer C by the FP sales manager D has a so-called <fixed product structure> in which the design details 1a are already fixed before the meeting with the customer C.

In the procedure of selling the FPD 1, the customer C frequently proposes his own desired FPD design details (for example, an investment period, an investment principal, a desired payment time and a desired payment amount of a desired on-term benefit, a desired payment amount of a desired maturity benefit, a desired payment time and a desired payment amount of a desired special benefit, or the like) (here, the desired special benefit means an event payment which the customer wishes to specially receive at a desired special benefit payment time according to the customer's circumstances, separately from the desired on-term benefit which is periodically paid (for example, monthly paid)) (for example, the customer may wish to receive 10 million won to prepare the entrance of his child into a university 30 months after the initiation of investment, during the entire investment period of 60 months).

However, as described above, since each FPD 1 introduced to the customer C by the FPD sales manager D (in this case, the FPD 1 is introduced as, for example, a pamphlet, a booklet, an excel file or the like) has a so-called <fixed product structure> in which design details 1a are already fixed before the meeting with the customer C, if the FPD 1 prepared by the FPD sales manager D fortunately covers FPD design details desired by the customer C, the FPD sales manager D may easily perform FPD business activity (FPD sales activity), but if not, the FPD sales manager D cannot perform normal FPD business activity (FPD sales activity) at all.

As a matter of course, in this circumstance, the FPD sales manager D or the FPD management company should be suffered from serious deterioration of business efficiency or sales efficiency of the FPD 1, and the customer C should also put up with unexpected financial damage on his asset since the customer C cannot rapidly invest or possess a desired FPD.

### DISCLOSURE

### Technical Problem

Therefore, the present disclosure is directed to providing a system for designing a financial product of a divisional payment type (FPD) according to a demand of a customer, and more particularly, to a FPD design supporting system in which a <computation module capable of storing and managing FPD relevant information and financial product of a maturity payment type (FPM) relevant information>, a <computation module capable of receiving desired FPD design information transmitted from a FPD sales manager communication terminal>, a <computation module capable of reading the received desired FPD design information, then extracting a <first combination object financial product> having an investment period and a payment time corresponding to an <investment period> and a <desired payment time of a desired on-term benefit> recorded in the desired FPD design information from the stored FPD, and extracting a <second combination object financial product> having an investment period and a payment time corresponding to an <investment period> and a <desired payment time of a desired special benefit> recorded in the desired FPD design information from the stored FPD or FPM>, a <computation module capable of reading the received desired FPD design information to check an investment principal of a customer and reading the first and second combination object financial products to check an inherent investment profit payment schedule of the corresponding first and second combination object financial products, and then simulating the investment principal of the customer according to the inherent investment profit payment schedule of the first and second combination object financial products to generate FPD payment schedule information to which a payment time and a payment amount of an on-term benefit, a payment time and a payment amount of a special benefit, and a payment time and a payment amount of a maturity benefit expected when the investment principal of the customer is divisionally invested to the first and second combination object financial products are reflected>, and a <computation module capable of reading the extracted first and second combination object financial products and the generated FPD payment schedule information, generating FPD design data to which the first and second combination object financial products and the FPD payment schedule information are reflected, and transmitting the generated FPD design data to the FPD sales manager communication terminal> are systematically arranged in a communication pipeline of a FPD sales manager communication terminal which is accessing an on-line network, thereby allowing a FPD sales manager to give FPD design details corresponding to a need of a customer, who is meeting the manager, in real time without any difficulty in order to prevent serious deterioration of FPD business efficiency or FPD sales efficiency in view of a FPD sales manager, a FPD management company and each customer, and also to solve a problem that a desired FPD cannot be invested or possessed rapidly.

Other objects of the present disclosure will become more clearly understood from the following detailed description and the accompanying drawings.

### Technical Solution

In an aspect, there is provided a system for supporting a design process of a financial product of a divisional payment type (FPD), the system including: a FPD design supporting control module for communicating with a FPD sales manager communication terminal accessing to an on-line network and operating a financial product information storage module storing FPD relevant information and financial product of a maturity payment type (FPM) relevant information to control a FPD design supporting procedure; a combination object financial product extraction module controlled by the FPD design supporting control module to read desired FPD design information transmitted from the FPD sales manager communication terminal and then search the financial product information storage module to extract a <first combination object financial product> having an investment period and a payment time corresponding to an <investment period> and a <desired payment time of a desired on-term benefit> recorded in the desired FPD design information from the FPD and a <second combination object financial product> having an investment period and a payment time corresponding to an <investment period> and a <desired payment time of a desired special benefit> recorded in the desired FPD design information from the FPD or FPM; a FPD payment schedule information generation module controlled by the FPD design supporting control module to read the desired FPD design information to check an investment principal of a customer and read the first and second combination object financial products to check an inherent investment profit payment schedule of the corresponding first and second combination object financial products, and then to simulate the investment principal of the customer according to the inherent investment profit payment schedule of the first and second combination object financial products to generate FPD payment schedule information to which a payment time and a payment amount of an on-term benefit, a payment time and a payment amount of a special benefit, and a payment time and a payment amount of a maturity benefit expected when the investment principal of the customer is divisionally invested to the first and second combination object financial products are reflected; and a FPD design data processing module controlled by the FPD design supporting control module and configured to communicate with the combination object financial product extraction module and the FPD payment schedule information generation module to read the first and second combination object financial products and the FPD payment schedule information, generate FPD design data to which the first and second combination object financial products and the FPD payment schedule information are reflected, and transmit the generated FPD design data to the FPD sales manager communication terminal.

### Advantageous Effects

Since a <computation module capable of storing and managing FPD relevant information and financial product of a maturity payment type (FPM) relevant information>, a <computation module capable of receiving desired FPD design information transmitted from a FPD sales manager communication terminal>, a <computation module capable of reading the received desired FPD design information, then extracting a <first combination object financial product> having an investment period and a payment time corresponding to an <investment period> and a <desired payment time of a desired on-term benefit> recorded in the desired FPD design information from the stored FPD, and extracting a <second combination object financial product> having an investment period and a payment time corresponding to an <investment period> and a <desired payment time of a desired special benefit> recorded in the desired FPD design information from the stored FPD or FPM>, a <computation module capable of reading the received desired FPD design information to check an investment principal of a customer and reading the first and second combination object financial products to check an inherent investment profit payment schedule of the corresponding first and second combination object financial products, and then simulating the investment principal of the customer according to the inherent investment profit payment schedule of the first and second combination object financial products to generate FPD payment schedule information to which a payment time and a payment amount of an on-term benefit, a payment time and a payment amount of a special benefit, and a payment time and a payment amount of a maturity benefit expected when the investment principal of the customer is divisionally invested to the first and second combination object financial products are reflected>, and a <computation module capable of reading the extracted first and second combination object financial products and the generated FPD payment schedule information, generating FPD design data to which the first and second combination object financial products and the FPD payment schedule information are reflected, and transmitting the generated FPD design data to the FPD sales manager communication terminal> are systematically arranged in a communication pipeline of a FPD sales manager communication terminal which is accessing an on-line network, the present disclosure may allow a FPD sales manager to give FPD design details corresponding to a need of a customer, who is meeting the manager, in real time without any difficulty, and as a result it is possible to prevent serious deterioration of FPD business efficiency or FPD sales efficiency in view of a FPD sales manager, a FPD management company and each customer, and also to solve a problem that a desired FPD cannot be invested or possessed rapidly.

### DESCRIPTION OF DRAWINGS

FIG. 1 is a schematic diagram for illustrating an existing FPD selling procedure.

FIG. 2 is a schematic diagram showing a FPD design supporting system according to the present disclosure.

FIG. 3 is a schematic diagram showing a posted content of a guide frame according to the present disclosure.

FIGS. 4 to 7 are schematic diagrams for illustrating detailed functions of the FPD design supporting system according to the present disclosure.

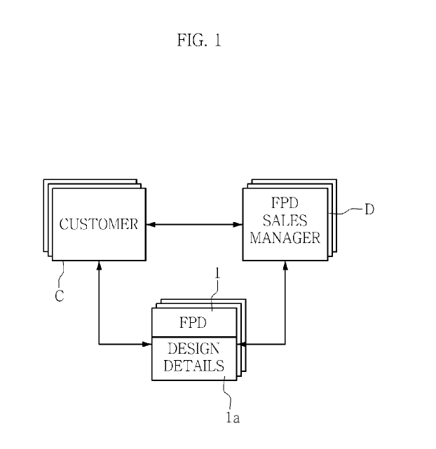

### BEST MODE

Hereinafter, a system for supporting a design process of a FPD (hereinafter, referred to as ‘a FPD design supporting system’ according to the present disclosure) will be described in detail with reference to the accompanying drawings.

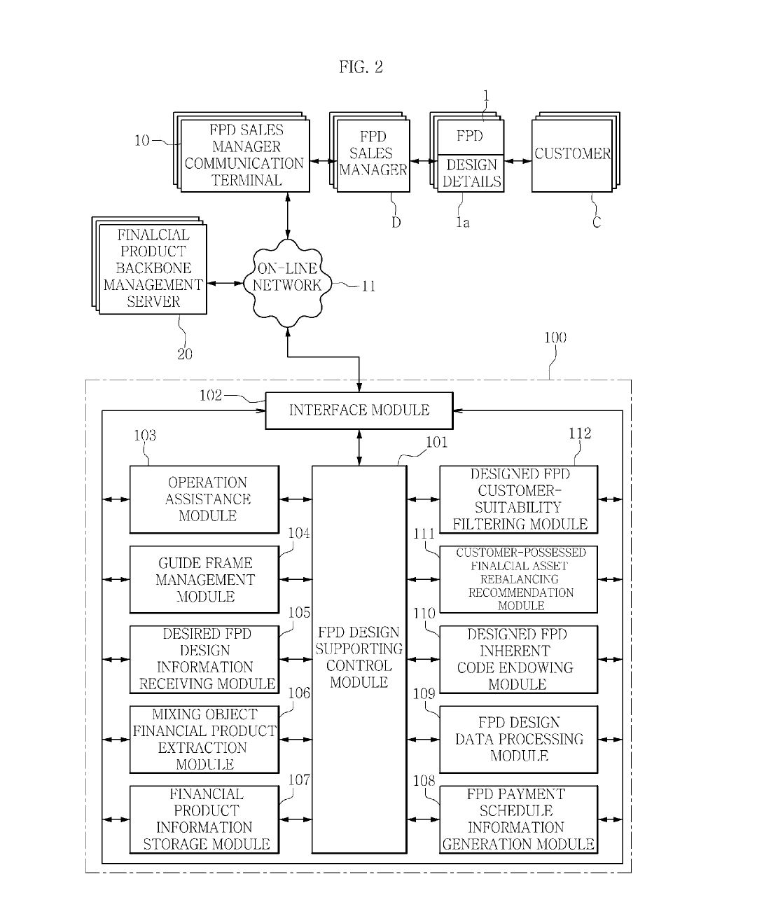

As shown in FIG. 2, in the present disclosure, at a meeting with a customer C, a FPD sales manager D introduces design details 1a (for example, a product type, an investment period, an available on-term benefit, an available maturity benefit or the like) of each FPD 1 and sells a corresponding FPD 1 to the customer C according to the selection of the customer who have reviewed the same. In this case, each FPD 1 introduced to the customer C by the FP sales manager D has a so-called <fixed product structure> in which the design details la are already fixed before the meeting with the customer C.

In the procedure of selling the FPD 1, the customer C frequently proposes his own desired FPD design details (for example, an investment period, an investment principal, a desired payment time and a desired payment amount of a desired on-term benefit, a desired payment amount of a desired maturity benefit, a desired payment time and a desired payment amount of a desired special benefit, or the like) (here, the desired special benefit means an event payment which the customer wishes to specially receive at a desired special benefit payment time according to the customer's circumstances, separately from the desired on-term benefit which is periodically paid (for example, monthly paid)) (for example, the customer may wish to receive 10 million won to prepare the entrance of his child into a university 30 months after the initiation of investment, during the entire investment period of 60 months).

However, since each FPD 1 introduced to the customer C by the FPD sales manager D (in this case, the FPD 1 is introduced as, for example, a pamphlet, a booklet, an excel file or the like) has a so-called <fixed product structure> whose design details 1a are already fixed before the meeting with the customer C, if the FPD 1 prepared by the FPD sales manager D fortunately covers FPD design details desired by the customer C, the FPD sales manager D may easily perform FPD business activity (FPD sales activity), but if not, the FPD sales manager D cannot perform normal FPD business activity (FPD sales activity) at all.

In this sensitive situation, in the present disclosure, an FPD design supporting system 100 is installed and operated in a communication infrastructure of an on-line network 11 (for example, wire/wireless Internet).

At this time, the FPD design supporting system 100 according to the present disclosure includes a FPD design supporting control module 101 communicating with a <FPD sales manager communication terminal 10 possessed by a FPD sales manager D>, a <financial product backbone management server 20 for computationally managing FPD, FPM or the like> by means of an on-line network 11 and an interface module 102 to control an overall supporting procedure in relation to a design of the FPD 1, and also includes an operation assistance module 103, a guide frame management module 104, a desired FPD design information receiving module 105, a combination object financial product extraction module 106, a financial product information storage module 107, a FPD payment schedule information generation module 108, a FPD design data processing module 109, a designed FPD customer-suitability filtering module 112, a customer-possessed financial asset rebalancing recommendation module 111, a designed FPD inherent code endowing module 110 or the like, which are controlled by the FPD design supporting control module 101 and closely combined with each other.

In this case, the FPD sales manager communication terminal 10 may be variously selected from, for example, computing devices such as notebook PC, desktop PC or the like, or mobile devices such as a cellular phone, a personal communication service (PCS) phone, a synchronous/asynchronous International Mobile Telecommunication-2000 (IMT-2000), a palm personal computer (PC), a personal digital assistant (PDA), a smart phone, a wireless application protocol (WAP) phone, a play station or the like according to a situation of the FPD sales manager D.

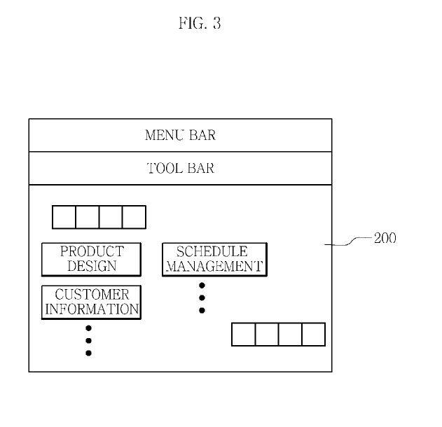

At this time, the operation assistance module 103 controlled by the FPD design supporting control module 101 stably stores and manages various kinds of operation information, required for performing the FPD design supporting service, for example, registration information of the FPD sales manager D, registration information of the FPD sales manager communication terminal 10, registration information of the financial product backbone management server 20, investment pattern information of each customer (information representing an investment pattern of each customer) (for example, a customer A is an investor who pursues stability, a customer B is an investor who bears a moderate risk, a customer C is an aggressive investor or the like), investment risk information of each financial product (information representing a degree of risk of each financial product) (for example, a financial product A is an investment product with a degree of risk of 10, a financial product B is an investment product with a degree of risk of 30, or the like), resource situation information of the system 100, component information required for performing a computing process of each computation module in the system 100, character/graphic/setting information for generating a guide frame 200 (see FIG. 3) or the like in its storage region (as a matter of course, the operation information listed above may be selectively added or deleted depending on a situation of the system 100).

In addition, the operation assistance module 103 performs various operation-assisting procedures required for performing the FPD design supporting service, for example a procedure for managing a system logging-in process of the FPD sales manager D, a procedure for establishing and managing a communication session to external computing devices 10, 20, a procedure for updating/managing the operation information, or the like.

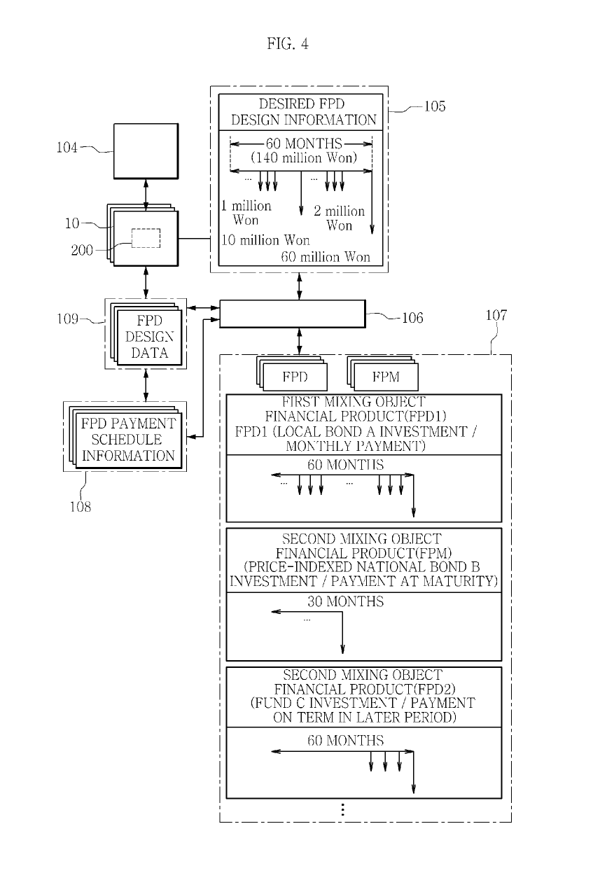

Further, when the FPD sales manager D who is meeting the customer C logs in to the system 100 through the FPD sales manager communication terminal 10, the guide frame management module 104 controlled by the FPD design supporting control module 101 communicates with the operation assistance module 103 to extract character/graphic/setting information for generating a guide frame 200, then utilizes the extracted character/graphic/setting information to generate the guide frame 200 as shown in FIG. 3, and transmits the generated guide frame 200 to the FPD sales manager communication terminal 10 so that the guide frame 200 is output and posted through the FPD sales manager communication terminal 10 as shown in FIG. 4.

At this time, the financial product information storage module 107 controlled by the FPD design supporting control module 101 stores and manages various relevant information in relation to FPD (for example, product code information, investment period information, investment profit payment time information, investment profit payment schedule information, investment earnings rate information, product risk index information or the like of each FPD), various relevant information in relation to FPM (for example, product code information, investment period information, investment profit payment time information, investment profit payment schedule information, investment earnings rate information, product risk index information or the like of each FPM) in its information storage region.

In a situation in which such an infrastructure is provided, as shown in FIG. 4, if the customer C or the FPD sales manager D performs a computing work by utilizing the guide frame 200 to transmit desired FPD design information of the customer C (for example, investment period information, investment principal information, desired payment time information and desired payment amount information of a desired on-term benefit, desired payment amount information of a desired maturity benefit, desired payment time information and desired payment amount information of a desired special benefit or the like) from the FPD sales manager communication terminal 10, the desired FPD design information receiving module 105 controlled by the FPD design supporting control module 101 communicates with the FPD sales manager communication terminal 10 through the interface module 102 to receive corresponding desired FPD design information (for example, investment period information, investment principal information, desired payment time information and desired payment amount information of a desired on-term benefit, desired payment amount information of a desired maturity benefit, desired payment time information and desired payment amount information of a desired special benefit or the like) and temporarily stores the information (see FIG. 4).

At this time, the desired FPD design information may be, for example, <an investment period: 60 months, an investment principal: 140 million won, a desired payment time of a desired on-term benefit: every month, a desired payment amount of a desired on-term benefit: 1 million won per month, a desired payment time of a desired special benefit 1: 30 months after initiating investment, a desired payment amount of a desired special benefit 1: 10 million won, a desired payment time of a desired special benefit 2: every month from 50^{th} month to 60^{th} month after initiating investment, a desired payment amount of a desired special benefit 2: 2 million won per month, a desired payment amount of a desired maturity benefit: 60 million won> or the like (see FIG. 4).

By doing so, if the desired FPD design information (for example, investment period information, investment principal information, desired payment time information and desired payment amount information of a desired on-term benefit, desired payment amount information of a desired maturity benefit, desired payment time information and desired payment amount information of a desired special benefit or the like) is completely received, the combination object financial product extraction module 106 controlled by the FPD design supporting control module 101 communicates with the desired FPD design information receiving module 105 to read the received desired FPD design information (for example, an investment period: 60 months, an investment principal: 140 million won, a desired payment time of a desired on-term benefit: every month, a desired payment amount of a desired on-term benefit: 1 million won per month, a desired payment time of a desired special benefit 1: 30 months after initiating investment, a desired payment amount of a desired special benefit 1: 10 million won, a desired payment time of a desired special benefit 2: every month from 50^{th} month to 60^{th} month after initiating investment, a desired payment amount of a desired special benefit 2: 2 million won per month, a desired payment amount of a desired maturity benefit: 60 million won).

If the desired FPD design information (for example, an investment period: 60 months, an investment principal: 140 million won, a desired payment time of a desired on-term benefit: every month, a desired payment amount of a desired on-term benefit: 1 million won per month, a desired payment time of a desired special benefit 1: 30 months after initiating investment, a desired payment amount of a desired special benefit 1: 10 million won, a desired payment time of a desired special benefit 2: every month from 50^{th} month to 60^{th} month after initiating investment, a desired payment amount of a desired special benefit 2: 2 million won per month, a desired payment amount of a desired maturity benefit: 60 million won) is completely read through the above procedure, the combination object financial product extraction module 106 communicates with the financial product information storage module 107 and searches the information storage region to extract an <investment period> and a <desired payment time of a desired on-term benefit> recorded in the desired FPD design information, and further a <first combination object financial product> having an investment period and a payment time corresponding to a <desired payment amount of a desired maturity benefit>, a <desired payment amount of a desired on-term benefit> or the like from the FPD stored in the corresponding information storage region (at this time, since the first combination object financial product has a relation with the desired on-term benefit of the customer, during the above procedure, the combination object financial product extraction module 106 searches only FPD and does not search FPM which is a maturity payment type product) (here, it should be specially noted that when a first combination object financial product having a plurality of on-term benefit payment events is selected as a FPM which is a maturity payment type product, a plurality of FPMs should be inevitably extracted and combined, which however inevitably forms a plurality of contract relations and thus greatly increases a management burden of a company) (as a matter of course, a computing process is also complicated to combine a plurality of FPMs, which additionally makes it difficult to perform the overall system) (as a result, in this consideration, the present disclosure provides and suggests an inherent technical feature of limiting the first combination object product to FPD).

At this time, if the desired FPD design information has information such as <an investment period: 60 months, a desired payment time of a desired on-term benefit: every month, a desired payment amount of a desired maturity benefit: 60 million won>, the combination object financial product extraction module 106 searches various relevant information in relation to FPD (for example, product code information, investment period information, investment profit payment time information, investment profit payment schedule information, investment earnings rate information or the like of each FPD) stored in the financial product information storage module 107, and extracts FPD1 (local bond A investment product/monthly payment) having a feature of <an investment period of 60 months/monthly payment of XX % in comparison to the investment principal/payment of XX % in comparison to the investment principal at the maturity date> as the <first combination object financial product> (see FIG. 4).

By doing so, in a situation in which the <investment period> and the <desired payment time of a desired on-term benefit> recorded in the desired FPD design information, and further the <first combination object financial product> having an investment period and a payment time corresponding to the <desired payment amount of a desired maturity benefit>, the <desired payment amount of a desired on-term benefit> or the like are extracted, the combination object financial product extraction module 106 communicates with the financial product information storage module 107 and searches its information storage region again to extract an <investment period> and a <desired payment time of a desired special benefit> recorded in the desired FPD design information, and further a <second combination object financial product> having an investment period and a payment time corresponding to a <desired payment amount of a desired maturity benefit> or the like from FPD or FPM stored in the corresponding information storage region (in this case, since the second combination object financial product has a relation with the desired special benefit of the customer, during the above procedure, the combination object financial product extraction module 106 searches both FPD and FPM).

At this time, if the desired FPD design information includes, for example, <a desired payment time of a desired special benefit 1: 30 months after initiating investment, a desired payment amount of a desired maturity benefit: 60 million won>, the combination object financial product extraction module 106 searches various relevant information in relation with FPD (for example, product code information, investment period information, investment profit payment time information, investment profit payment schedule information, investment earnings rate information or the like of each FPD) and various relevant information in relation with FPM (for example, product code information, investment period information, investment profit payment time information, investment profit payment schedule information, investment earnings rate information or the like of each FPM), stored in the financial product information storage module 107, to extract FPM (price-indexed national bond investment product/maturity payment type) having a feature of <an investment period of 30 months/payment of XX % in comparison to the investment principal at the maturity date> as the <second combination object financial product> (see FIG. 4).

In addition, if the desired FPD design information includes, for example, <an investment period: 60 months, a desired payment time of a desired special benefit 2: every month from 50^{th} month to 60^{th} month after initiating investment, a desired payment amount of a desired special benefit 2: 2 million won per month, a desired payment amount of a desired maturity benefit: 60 million won>, the combination object financial product extraction module 106 searches various relevant information in relation to FPD (for example, product code information, investment period information, investment profit payment time information, investment profit payment schedule information, investment earnings rate information or the like of each FPD) and various relevant information in relation to FPM (for example, product code information, investment period information, investment profit payment time information, investment profit payment schedule information, investment earnings rate information or the like of each FPM), stored in the financial product information storage module 107, to extract FPD2 (fund C investment product/on-term benefit in later period) having a feature of <an investment period of 60 months/monthly payment of XX % in comparison to the investment principal at 50^{th} to 60^{th} months from the investment date/payment of XX % in comparison to the investment principal at the maturity date> as another <second combination object financial product> (see FIG. 4).

If FPD 1 (local bond A investment product/monthly payment) having a feature of <an investment period of 60 months/monthly payment of XX % in comparison to the investment principal/payment of XX % in comparison to the investment principal at the maturity date>, FPM (price-indexed national bond investment product/maturity payment type) having a feature of <an investment period of 30 months/payment of XX % in comparison to the investment principal at the maturity date>, FPD2 (fund C investment product/on-term benefit in later period) having a feature of <an investment period of 60 months/monthly payment of XX % in comparison to the investment principal at 50^{th} to 60^{th} months from the investment date/payment of XX % in comparison to the investment principal at the maturity date> or the like are completely extracted as the <first combination object financial product> and the <second combination object financial product> through the above procedure, the FPD payment schedule information generation module 108 controlled by the FPD design supporting control module 101 reads the desired FPD design information to check the investment principal of the customer and reads the first and second combination object financial products to check an inherent investment profit payment schedule of the corresponding first and second combination object financial products.

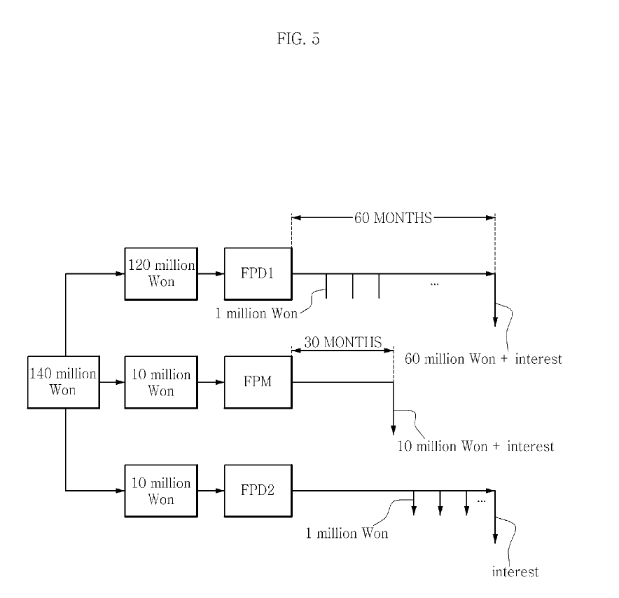

By doing so, if the investment principal of the customer and the inherent investment profit payment schedule of the first and second combination object financial product are completely checked, as shown in FIG. 5, the FPD payment schedule information generation module 108 simulates the investment principal of the customer according to the inherent investment profit payment schedule of the first and second combination object financial product, thereby generating FPD payment schedule information to which the <payment time and payment amount of an on-term benefit>, the <payment time and payment amount of a special benefit>, and the <payment time and payment amount of a maturity benefit>, expected when the investment principal of the customer is divisionally invested to the first and second combination object financial products, is reflected.

At this time, as shown in FIG. 5, for example, if the investment principal of the customer is 140 million won, the first combination object financial product is FPD1 (local bond A investment product/monthly payment) having an inherent investment profit payment schedule of <an investment period of 60 months/monthly payment of XX % in comparison to the investment principal/payment of XX % in comparison to the investment principal at the maturity date>, the second combination object financial product is FPM (price-indexed national bond investment product/maturity payment type) having an investment profit payment schedule of <an investment period of 30 months/payment of XX % in comparison to the investment principal at the maturity date> and FPD2 (fund C investment product/on-term benefit in later period) having a feature of <an investment period of 60 months/monthly payment of XX % in comparison to the investment principal at 50^{th} to 60^{th} months from the investment date/payment of XX % in comparison to the investment principal at the maturity date>, the FPD payment schedule information generation module 108 simulates 140 million won of the investment principal of the customer according to the inherent investment profit payment schedule of the first and second combination object financial products, thereby generating FPD payment schedule information having details of, for example, <if 140 million won of the investment principal is divisionally invested to FPD1, FPM and FPD2 as much as 120 million won, 10 million won and 10 million won, respectively, according to the management of FPD1, 1 million won will be paid every month as a bonus amount, and 60 million won and an interest XX will be paid 60 months after initiating the investment. In addition, according to the management of FPM, 10 million won and an interest XX will be paid after 30 months. Further, according to the management of FPD2, 1 million won will be paid from 50^{th} month to 60^{th} month after initiating investment as a bonus, and an interest XX will be paid at the maturity date>.

Meanwhile, if the FPD payment schedule information to which the <payment time and payment amount of an on-term benefit>, the <payment time and payment amount of a special benefit>, and the <payment time and payment amount of a maturity benefit>, expected when the investment principal of the customer is divisionally invested to the first and second combination object financial products, is reflected is completely generated, the FPD design data processing module 109 controlled by the FPD supporting control module 101 communicates with the combination object financial product extraction module 106, the FPD payment schedule information generation module 108 or the like to read the first and second combination object financial product and the FPD payment schedule information.

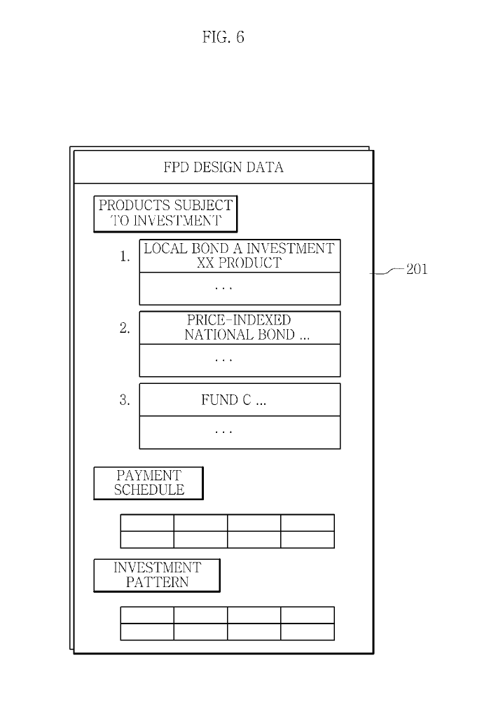

By doing so, if the first and second combination object financial products, the FPD payment schedule information or the like are completely read, the FPD design data processing module 109 performs a series of data generating routines to generate FPD design data 201 to which the first and second combination object financial product, the FPD payment schedule information or the like are reflected as shown in FIG. 6, and then communicates with the FPD sales manager communication terminal 10 through the interface module 102, the on-line network 11 or the like to transmit the generated FPD design data 201 to the FPD sales manager communication terminal 10.

As a matter of course, in such an implementation circumstance of the present disclosure, the customer C and the FPD sales manager D may easily check a financial product combination in which benefit payments (on-term benefit and special benefit) corresponding to the desired FPD design information are complicatedly combined, and may easily check the FPD payment schedule information having details of, for example, <if 140 million won of the investment principal is divisionally invested to FPD1, FPM and FPD2 as much as 120 million won, 10 million won and 10 million won, respectively, according to the management of FPD1, 1 million won will be paid every month as a bonus amount, and 60 million won and an interest XX will be paid 60 months after initiating the investment. In addition, according to the management of FPM, 10 million won and an interest XX will be paid after 30 months. Further, according to the management of FPD2, 1 million won will be paid from 50^{th} month to 60^{th} month after initiating investment as a bonus, and an interest XX will be paid at the maturity date>. As a result, the FPD sales manager D may provide FPD design details corresponding to a need of the customer, who is meeting the manager, in real time without any difficulty, and may also maximize his FPD business efficiency or sales efficiency to an optimal state.

Meanwhile, the designed FPD customer-suitability filtering module 112, the customer-possessed financial asset rebalancing recommendation module 111, the designed FPD inherent code endowing module 110 or the like may be further controlled by the FPD design supporting control module 101 in addition to the above computation modules.

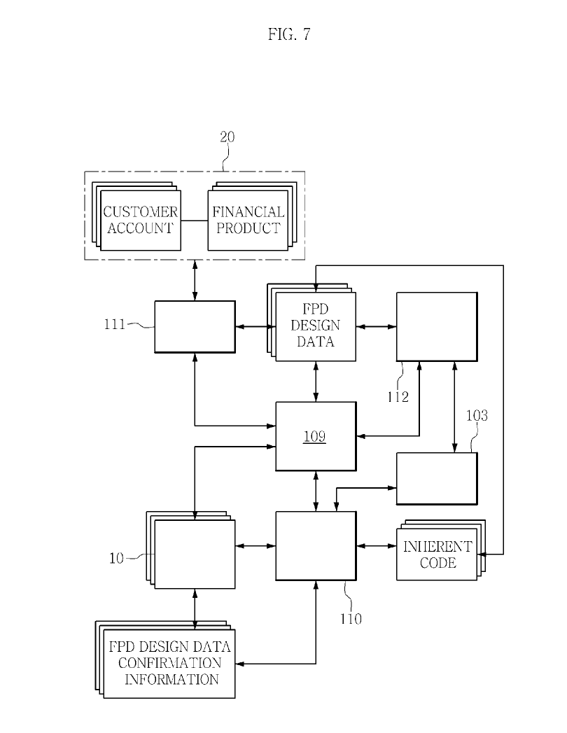

At this time, the designed FPD customer-suitability filtering module 112 controlled by the FPD design supporting control module 101 communicates with the FPD design data processing module 109 and the operation assistance storage module 103 as shown in FIG. 7 to the first and second combination object financial products recorded in the FPD design data 201 with the stored investment pattern information of each customer (information representing an investment pattern of each customer) (for example, a customer A is an investor who pursues stability, a customer B is an investor who bears a moderate risk, a customer C is an aggressive investor or the like), investment risk information of each financial product (information representing a degree of risk of each financial product) (for example, a financial product A is an investment product with a degree of risk of 10, a financial product B is an investment product with a degree of risk of 30, or the like) or the like, thereby performing a filtering process for checking whether the first and second combination object financial products accord with an investment pattern of the customer.

At this time, if the first and second combination object financial products are determined not to accord with the investment pattern of the customer (for example, the customer is an investor who pursues stability, but the second combination object financial product is an investment product with a high risk), the designed FPD customer-suitability filtering module 112 generates a <designed FPD filtering message> to which the filtering result is reflected, and transmits the generated <designed FPD filtering message> to the FPD design data processing module 109.

As a matter of course, in this situation, the FPD design data processing module 109 communicates with the combination object financial product extraction module 106, the FPD payment schedule information generation module 108 or the like to selectively take additional measures corresponding thereto (for example, an additional measure for deleting the corresponding combination object financial product, searching another combination object financial product, and generating FPD design data again), and as a result, the finally generated FPD design data 201 of the present disclosure may effectively maintain its reliable quality which optimally agrees with the situation of the customer.

Meanwhile, the customer-possessed financial asset rebalancing recommendation module 111 controlled by the FPD design supporting control module 101 together with the computation modules described above communicates with the FPD design data processing module 109 and, at the point that the FPD design data 201 is generated, also communicates with the financial product backbone management server 20 through the interface module 102, the on-line network 11 or the like to search a customer account managed by them, thereby checking details of <whether the customer who has proposed the desired FPD design information already has a financial product (for example, a financial product having a investment period and a payment time similar to those of the first and second combination object financial products recorded in the FPD design data 201) (as a matter of course, this may be a common financial product)>.

At this time, if it is checked that <the customer already who has proposed the desired FPD design information already has a financial product>, the customer-possessed financial asset rebalancing recommendation module 111 performs a series of data generating routines to generate <possessed financial product rebalancing recommendation information> for guiding the customer to obtain an effect similar to an investment to the first and second combination object financial products by rebalancing the corresponding financial product, and then transmits the generated <possessed financial product rebalancing recommendation information> to the FPD design data processing module 109.

As a matter of course, in this situation, the FPD design data processing module 109 additionally records the <possessed financial product rebalancing recommendation information> in the FPD design data 201 provided to the FPD sales manager communication terminal 10, and as a result the FPD sales manager D checking the same through the FPD sales manager communication terminal 10 may guide the corresponding customer C to <obtain an effect similar to an investment to the first and second combination object financial products by rebalancing the financial product already possessed by the customer> through a consultation with the customer C.

Meanwhile, in a situation that the FPD design data 201 is transmitted to the FPD sales manager communication terminal 10 by the FPD design data processing module 109, the designed FPD inherent code endowing module 110 controlled by the FPD design supporting control module 101 together with the computation modules described above communicates with the FPD sales manager communication terminal 10 through the interface module 102, the on-line network 11 or the like to check whether the <FPD design data confirmation information> corresponding to the FPD design data 201 is transmitted from the FPD sales manager communication terminal 10.

At this time, a contract is concluded if the customer C accepts the details of the FPD design data 201. Accordingly, if the <FPD design data confirmation information> corresponding to the FPD design data 201 is transmitted from the FPD sales manager communication terminal 10, the designed FPD inherent code endowing module 110 instantly performs a series of data generating routines to generate an inherent code corresponding to the FPD design data 201, and endows the generated inherent code to the FPD design data 201.

As a matter of course, if the inherent code is endowed to the FPD design data 201 by the designed FPD inherent code endowing module 110, the FPD sales manager D or the FPD sales company may perform ex post facto management for the FPD (for example, a procedure for registering FPD sales details to the financial product backbone management server 20, a procedure of investing the investment money of the customer to each investment product according to the FPD sales details, or the like) without any difficulty more reliably.

The present disclosure is not limited to specific fields but may give useful effects as a whole in various fields in which accompanied growth is required.

In addition, even though specific embodiments of the present disclosure have been described and illustrated, it is obvious that the present disclosure can be modified in various ways by those skilled in the art.

Such modifications should not be understood separate from the scope of the present disclosure, but such modification should be regarded as falling into the scope of the present disclosure defined in the appended claims.

### INDUSTRIAL APPLICABILITY

If the present disclosure is implemented, a FPD sales manager may FPD design details corresponding to a need of a customer, who is meeting the manager, in real time without any difficulty, and as a result it is possible to prevent serious deterioration of FPD business efficiency or FPD sales efficiency in view of a FPD sales manager, a FPD management company and each customer, and also to solve a problem that a desired FPD cannot be invested or possessed rapidly.

1. A system for supporting a design process of a financial product of a divisional payment type (FPD), the system comprising:
a FPD design supporting control module for communicating with a FPD sales manager communication terminal accessing to an on-line network and operating a financial product information storage module storing FPD relevant information and financial product of a maturity payment type (FPM) relevant information to control a FPD design supporting procedure;
a combination object financial product extraction module controlled by the FPD design supporting control module to read desired FPD design information transmitted from the FPD sales manager communication terminal and then search the financial product information storage module to extract a <first combination object financial product> having an investment period and a payment time corresponding to an <investment period> and a <desired payment time of a desired on-term benefit> recorded in the desired FPD design information from the FPD and a <second combination object financial product> having an investment period and a payment time corresponding to an <investment period> and a <desired payment time of a desired special benefit> recorded in the desired FPD design information from the FPD or FPM;
a FPD payment schedule information generation module controlled by the FPD design supporting control module to read the desired FPD design information to check an investment principal of a customer and read the first and second combination object financial products to check an inherent investment profit payment schedule of the corresponding first and second combination object financial products, and then to simulate the investment principal of the customer according to the inherent investment profit payment schedule of the first and second combination object financial products to generate FPD payment schedule information to which a payment time and a payment amount of an on-term benefit, a payment time and a payment amount of a special benefit, and a payment time and a payment amount of a maturity benefit expected when the investment principal of the customer is divisionally invested to the first and second combination object financial products are reflected; and
a FPD design data processing module controlled by the FPD design supporting control module and configured to communicate with the combination object financial product extraction module and the FPD payment schedule information generation module to read the first and second combination object financial products and the FPD payment schedule information, generate FPD design data to which the first and second combination object financial products and the FPD payment schedule information are reflected, and transmit the generated FPD design data to the FPD sales manager communication terminal.

2. The system for supporting a design process of a FPD according to claim 1,
wherein when extracting the first combination object financial product or the second combination object financial product, the combination object financial product extraction module refers to a <desired payment amount of a desired maturity benefit> and a <desired payment amount of a desired on-term benefit> recorded in the desired FPD design information.

3. The system for supporting a design process of a FPD according to claim 1, further comprising:
a customer-possessed financial asset rebalancing recommendation module controlled by the FPD design supporting control module and is configured to communicate with a financial product backbone management server which manages the FPD and the FPM,
wherein when it is checked that the customer has a financial product, the customer-possessed financial asset rebalancing recommendation module generates a <possessed financial product rebalancing recommendation information> for guiding the customer to obtain an effect similar to an investment to the first and second combination object financial products by rebalancing the corresponding financial product and transmits the generated <possessed financial product rebalancing recommendation information> to the FPD design data processing module.

4. The system for supporting a design process of a FPD according to claim 1, further comprising:
a designed FPD customer-suitability filtering module controlled by the FPD design supporting control module to compare the first and second combination object financial products recorded in the FPD design data with investment pattern information of each customer and investment risk information of each financial product, already stored, to perform a filtering process for checking whether the first and second combination object financial products accord with an investment pattern of the customer.

5. The system for supporting a design process of a FPD according to claim 1, further comprising:
a designed FPD inherent code endowing module controlled by the FPD design supporting control module and configured to generate an inherent code corresponding to the FPD design data and endows the generated inherent code to the FPD design data when FPD design data confirmation information corresponding to the FPD design data is transmitted from the FPD sales manager communication terminal in a situation where the FPD design data processing module transmits the FPD design data to the FPD sales manager communication terminal.
